(19) United States
(12) Patent Application Publication
(10) Pub. No.: US 2012/0151565 A1
(43) Pub. Date: Jun. 14, 2012

(54) SYSTEM, APPARATUS AND METHOD FOR IDENTIFYING AND BLOCKING ANOMALOUS OR IMPROPER USE OF IDENTITY INFORMATION ON COMPUTER NETWORKS

(76) Inventor: ERIC FITERMAN, Odenton, MD (US)

(21) Appl. No.: 13/323,372

(22) Filed: Dec. 12, 2011

Related U.S. Application Data
(60) Provisional application No. 61/421,799, filed on Dec. 10, 2010.

(51) Int. Cl. G06F 21/00; H04W 12/06

(52) U.S. Cl. 726/7

(57) ABSTRACT

A system, apparatus and method is described for a security platform and/or identity platform for identifying, notifying, reporting and blocking pass-the-hash attacks and the anomalous or improper use of identity information on computer networks. The system, apparatus or method follows a policy of zero-trust, and does not rely on any client or server information to verify or confirm identity. Instead, the system, apparatus or method of the invention monitors communications between network devices, and when a first device transmits a communication of interest to a second device, the system, apparatus or method of the invention queries the first device directly to determine whether the transmission is authorized.

### FIELD OF THE INVENTION

The present invention relates to computer networks, and in particular to identifying and blocking improper use of identity information on computer networks.

### BACKGROUND OF THE INVENTION

Computer networks are vulnerable to specific types of account forgery and identity abuse attacks. Microsoft authentication mechanisms use password ‘hashes’, not readable passwords, to construct user account requests, authorization, and authentication actions between member computers on a network. On a running computer, these hashes are often available to any user with administrative privileges. If an attacker is able to compromise password hashes or cached credentials from one computer on a network, the attacker is able to use these raw password hashes to impersonate the user from whom these hashes have been stolen. One-term used to describe these attacks are ‘pass the hash’ attacks. These types of attacks are highly undesirable since they specifically target medium and large networks, where shared hashes are likely to be found across the entire network. Thus, the compromise of just one account on a network host may render the entire network at risk. Attackers use this technique to traffic in stolen account and identity information on an internal computer network.

In addition, typical network traffic makes extensive use of protocols such as Server Message Block (SMB), Remote Procedure Call (RPC), Kerberos, and the Common Internet File System (CIFS), which carry user data over the network. This user data reflects various characteristics and properties which may be indicative of outdated/legacy authentication or improper, unauthorized, or illegal computer activity. Some examples include file names, user names, identities, computer names, domain names, dates and times, authentication mechanisms, security features, and other attributes.

In addition, large networks frequently may have legacy devices and software that use legacy, outdated, or insecure authentication mechanisms. The design presented in this document is capable of identifying these devices and communications to allow a network owner to remove or upgrade systems to allow for more up-to-date security.

### SUMMARY OF THE INVENTION

The system described in this document provides a set of functions, inputs, and outputs for preventing the abuse of identity information, specifically addressing attacks like the pass-the-hash technique or similar attack vectors. The system may be implemented as a software-based solution, application, script, binary, service, cloud-based service, virtual application, virtual machine, a bundled multi-tier virtual machines/appliances/devices, or virtual server. Or, the system may be comprised of dedicated, custom hardware using programmable logic or custom hardware designed to provide the functionality described herein. The solution may also be implemented using a combination of these or similar hardware and software mechanisms. The system may constitute a set of automated or manual processes and technologies. While the examples in this document illustrate a security device, this depiction is intended to describe a logical set of functionality - not a single, physical device. The security device depicted in the included diagrams could represent a virtual or software device, desktop application, embedded device, embedded appliance, virtual appliance, virtual application, virtual machine, cloud-based service, web service, software mechanism, web-based service, hardware device, or a hybrid of these. The system may be described as either a hosted or managed technology. The device also may be composed of elements that are collocated on the same medium, or located in distinct areas of a computer network or the Internet; the totality of functionality described in this document could be partitioned into distinct components that reside within different areas of a computer network. For example, one logical mechanism may provide the ability to monitor network traffic on one segment of the network, while another separate mechanism in a different segment would communicate with this network component to validate user identity information captured from the network.

The system described in this document is capable of processing, inspecting, examining, querying, blocking and modifying network data and data resident on other network devices, appliances, hosts, servers, domain controllers, identity management systems, infrastructure, workstations, security devices, virtual servers, cloud-based devices, storage devices, storage arrays, and other digital or electronic systems. The mechanisms to support the processing, inspection, examination, query, blocking, and modification of data passing on a network or resident on network devices, appliances, hosts, servers, workstations, security devices, virtual servers, cloud-based devices, storage devices, storage arrays, and other digital or electronic systems may be performed using a ‘monolithic’, bundled set of technologies, or through an independent, federated set of technologies.

While the diagrams included herein depict identity transactions between computer devices, the system described in this document can be used to detect, notify, report, and block the malicious or anomalous exchange and transfer of identity information passed to a variety of systems: servers, domain controllers, directory servers, identity management systems, database servers, web servers, VPN/remote access systems, storage arrays, workstations, wireless devices, desktops, remote shares, remote registries, web applications, databases, datastores, web services, remote access systems, security devices, mobile devices, cloud-based services, email systems, software applications, scripts, utilities and web portals. While the diagrams included herein depict identity transactions on a computer network, the system can operate on local area networks, wide area networks, large enterprise networks, small and medium sized networks, global computer networks, wired networks, wireless networks, telephone networks, switched networks, routed networks, virtual private networks, distributed networks, satellite networks, closed networks, or open networks.

The system is capable of making an assessment of whether to report, identify, block, prompt, modify, or pass data depending on configurable parameters provided by the end-users, internal rules, logic, predefined signatures, location information, client or server computer characteristics, date or time attributes, intelligent algorithms, adaptive security processes, forensic inspection, decision processes, and other forms of logic. Inputs to the system may include volatile system data, network data, registry information, metadata, data files, log information, syslog messages, event log data, databases, running services, datastores, aggregated log feeds, network flows (netflows), VPN data, proprietary signatures, email communications, firewall alerts, anti-virus alerts, anti-virus signatures, transaction records, packet captures, engine rule sets, manual input, open source information, or in-memory data. Unique combinations of attributes from these various input sources can be used to determine the legitimacy of activity observed on a network. Outputs may be delivered to other automated systems, manual processes, databases, mobile devices, email systems, web services, cloud-services, logging processes/daemons, files, events, inter-process communication mechanisms.

The system is capable of monitoring all types of network traffic, including TCP, UDP, SMB, CIFS, Kerberos, RPC, and other communications protocols in order to perform the functionality described in this document. The system may be capable of monitoring traffic and enforcing specific flow or security policies, and may also have visibility into ‘sideways’ connections within a network, by using information derived from directory services, such as Microsoft's Active Directory implementation or Kerberos. The system may also have the ability to alter portions of session establishment protocols, for example the CIFS negotiate protocol messaging, whereby the system may reduce or alter the protocols offered to the client. Thus, the system could negotiate protocols ‘up’ (to a higher security implementation) or ‘down’ (to a lower security implementation) depending on system requirements.

In addition to blocking undesirable activity, the system is capable of performing host containment, disconnect, kill, isolation, wiping or segregation. The principle of this feature is to allow isolation of compromised hosts in an automated or manual fashion. This allows the system to perform host isolation after a host has established some form of connection with another computer. Thus, the system is capable of blocking activity during the establishment of connections to other resources, or may be able to perform after-the-fact isolation and containment after the system has made a ‘go’/‘no-go’ decision about the hosts involved. This could be considered a form of just-in-time containment: a type of isolation that may not occur by a system that sits in-line between a client and server, but instead a mechanism that receives network activity through a span port, network tap, or other means to distribute or route network communications distribution, but is capable of performing some action just after the fact to minimize the potential for disruption.

This design describes a type of security device, appliance, software, multi-tiered system, or firewall that operates on identity information to identify and block unauthorized activity. Examples of some of these representative abuses case detected by the system are described below.

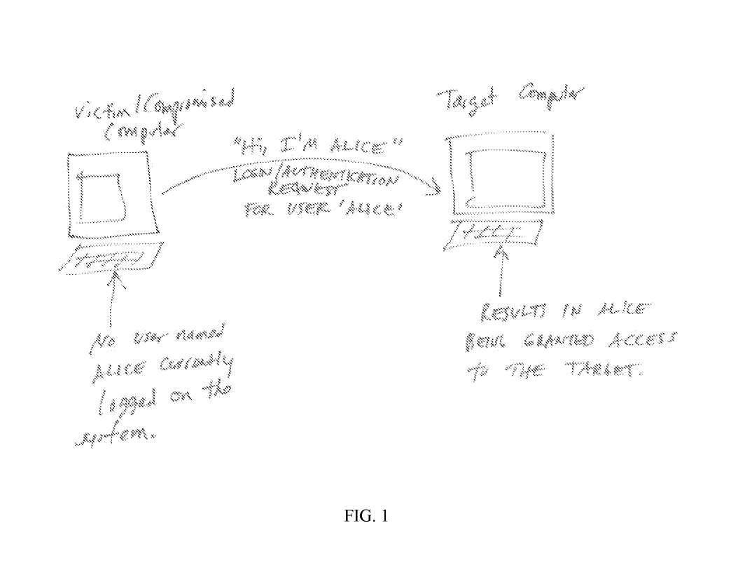

Example A: The activity is generated from a user account/identity that has not performed an interactive login to the computer terminal. As shown in FIG. 1, a “victim” computer has been compromised. The victim computer sends a login/authentication request for user “Alice” to a target computer, even though no user named “Alice” is logged onto the system. The malicious code that has compromised the victim computer has extracted residue that identifies users and allows uses to conduct business over the network without requiring re-authentication. The malicious code uses this information to send the login/authentication request to the target computer. Therefore, because the login/authentication request contains information, extracted from the victim computer, that suggest to the target computer that the request is authentic, the request results in the malicious code masquerading as “Alice” being granted access to the target computer.

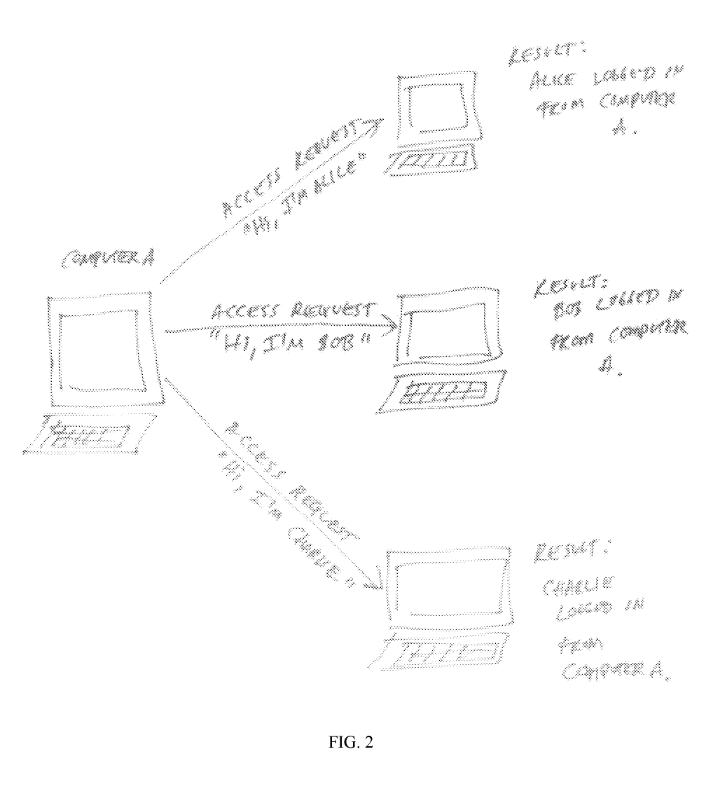

Example B: The attacker may generate outbound requests from a single machine with differing user names. As shown in FIG. 2, malicious code may extract identity from multiple users from a compromised computer and send access requests to multiple computers, with the result that different computers on the network can reflect that a different user is logged on from the compromised computer.

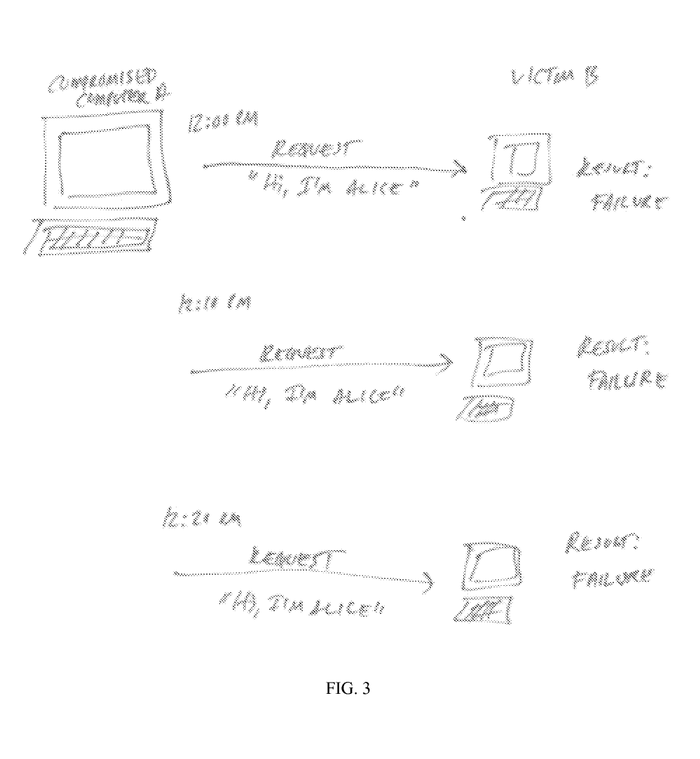

Example C: A number of hosts on the network may reflect regular login failures with a specific frequency. As shown in FIG. 3, a computer may send multiple requests to a particular target computer. Multiple request failures may indicate that the originating computer is compromised.

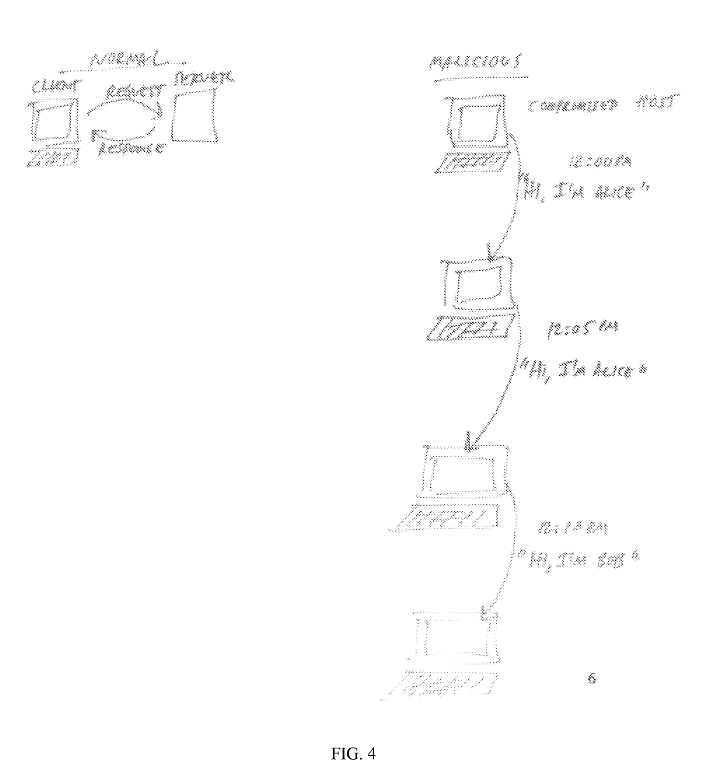

Example D: The same user identity is observed traversing through several network peers, not the expected client-server activity normally seen with user login sessions, or a login/authentication chain is created showing authentication hopping. FIG. 4 shows a normal (not-compromised computer) having a normal request-response interaction with a server, together with a pattern of authentication hopping indicative of a compromised host.

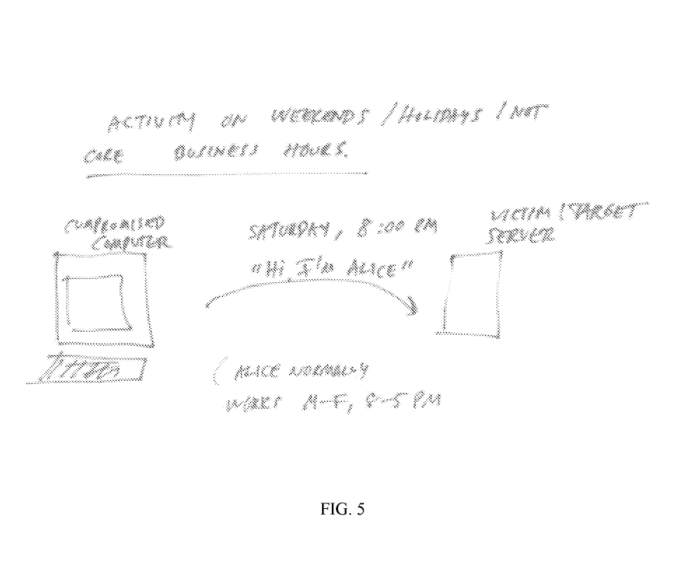

Example E: User identity activity occurs during irregular or unusual timeframes inconsistent with normal user activity. FIG. 5 shows an example of an authentication request from one computer to another occurring at a day and time that would suggest that the originating computer is compromised. For example, if a user normally works standard business hours, e.g., Monday through Friday, from 8 am to 5 pm, and a request for access to another computer is sent at 8 am on Saturday, this might suggest that the request for access is the result of malicious code residing on a compromised computer.

There are several novel and unique technical designs to combat these problems. These capabilities may be integrated into the system to detect, report, and block malicious activity.

### DESCRIPTION OF THE DRAWINGS

The subsequent description of the preferred embodiments of the present invention refers to the attached drawings, wherein:

a. FIG. 1 is representation of one kind of computer attack that may be detected and blocked according to embodiments of the invention.

b. FIG. 2 is a representation of another kind of computer attack that may be detected and blocked according to embodiments of the invention.

c. FIG. 3 is a representation of a set of circumstances that may reflect a type of computer attack that may be detected and blocked according to embodiments of the invention.

d. FIG. 4 is representative comparison between normal client server communication and malicious client/server/client communications.

e. FIG. 5 is a representation of computer activity that might indicate information suggesting a type of computer attack that may be detected and blocked according to embodiments of the invention.

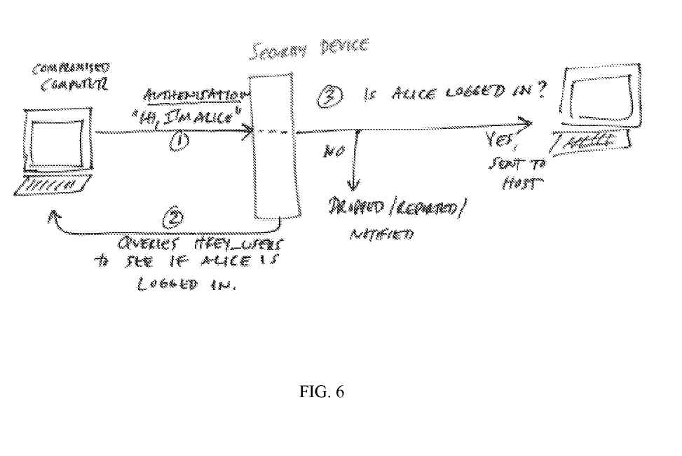

f. FIG. 6 represents an embodiment of the invention according to which the invention examines the system registry for loaded profiles in HKEY_USER registry or other workstation data artifact to detect and/or block computer attacks.

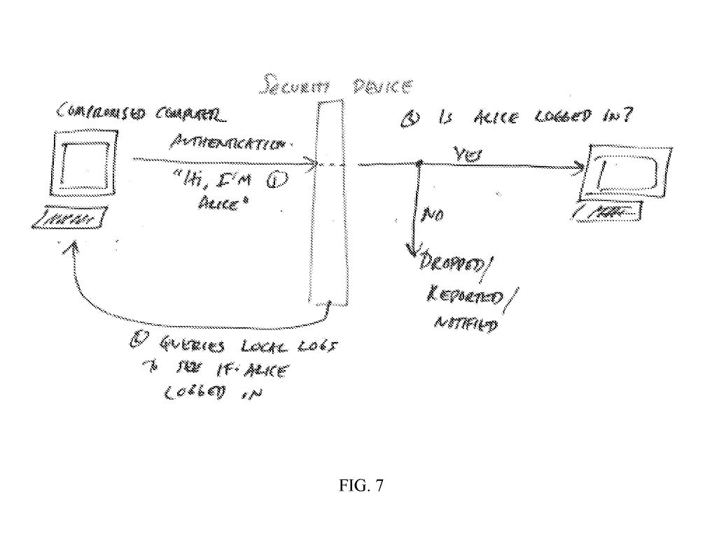

g. FIG. 7 represents an embodiment of the invention according to which the invention examines local system log data to identify interactive logins or failed login/pass-the-hash signatures.

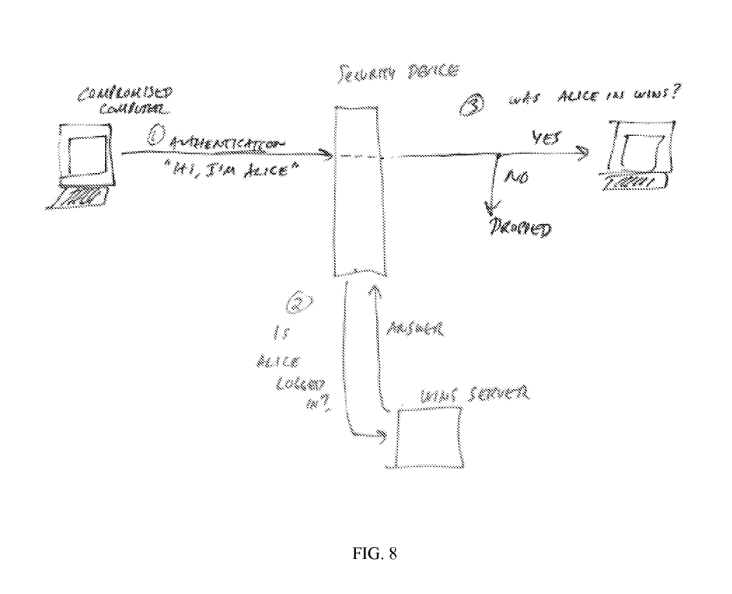

h. FIG. 8 represents an embodiment of the invention according to which the invention queries WINS servers for login information for a particular user.

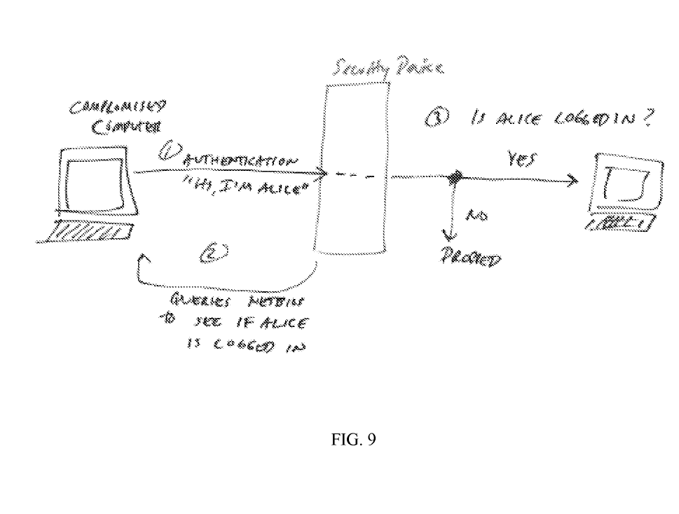

i. FIG. 9 represents an embodiment of the invention according to which the invention queries netbios for logged-in users.

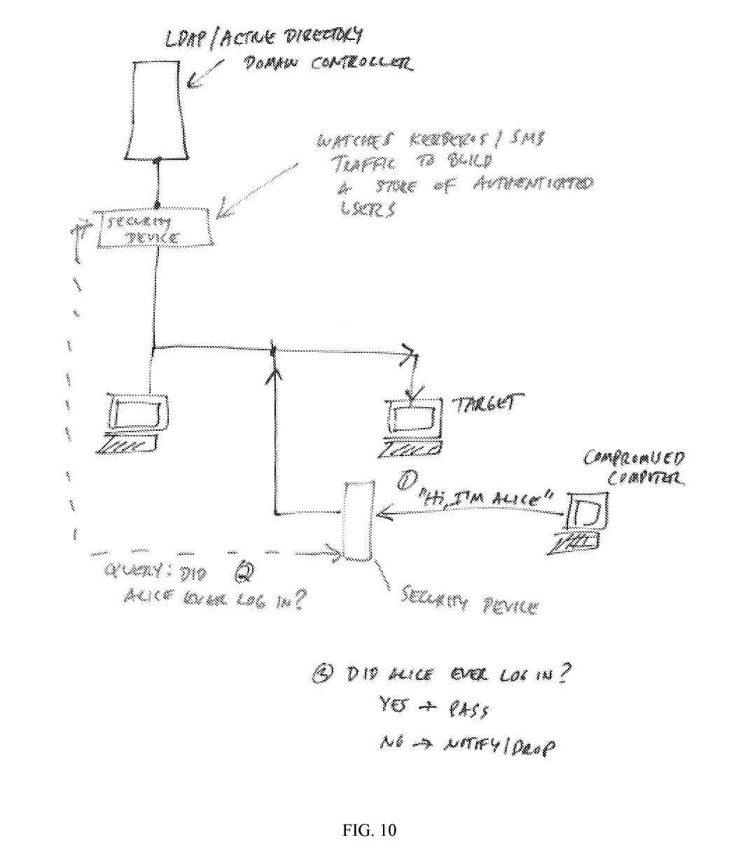

j. FIG. 10 represents an embodiment of the invention according to which sensors or logic may be deployed in line with, or receive feeds from directory servers to watch for events characteristic of a legitimate login, and in which another set of sensors or devices or logic may be deployed to query this standalone repository of identify information or logic.

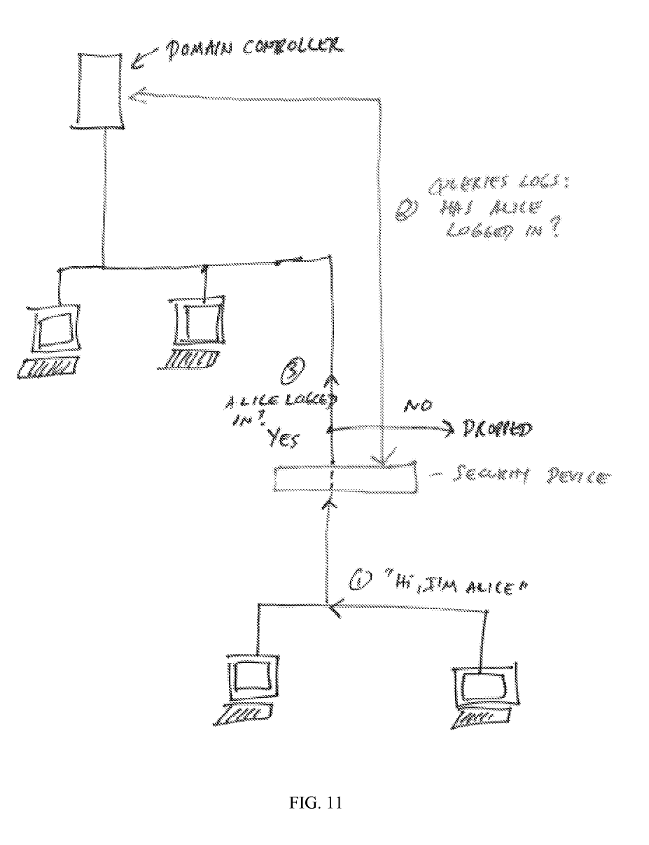

k. FIG. 11 represents an embodiment of the invention according to which enterprise log data, active directories, and/or Kerberos logs are queried for valid interactive and/or console logs.

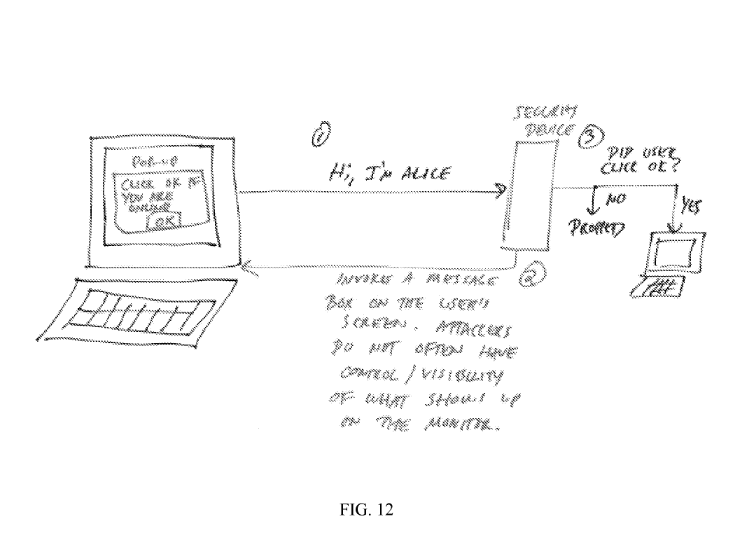

l. FIG. 12 represents an embodiment of the invention according to which the invention sends a message or triggers an event that results in a user prompt to validate the user's full password or other attribute(s) indicating the user's presence at his or her terminal.

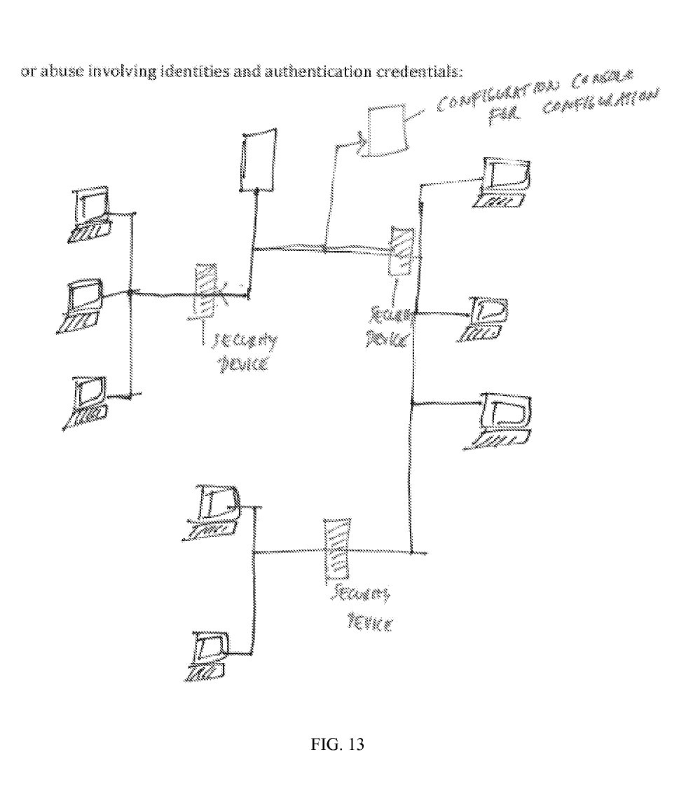

m. FIG. 13 represents an embodiment of the invention according to which a central configuration console is used to send and receive configuration data for multiple sensors on a network.

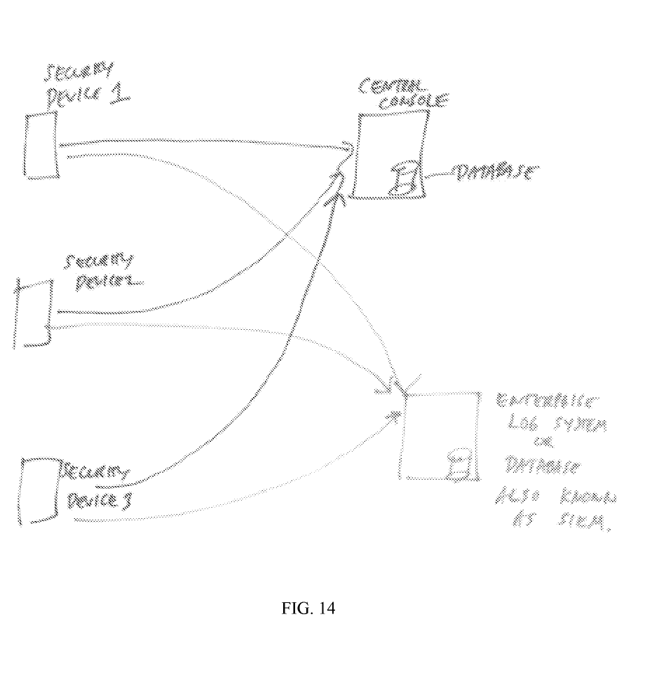

n. FIG. 14 is a further representation of the embodiment of the invention shown in FIG. 13, according to which sensors track and report network activity to a central console as well as optionally to an integrated log management solution.

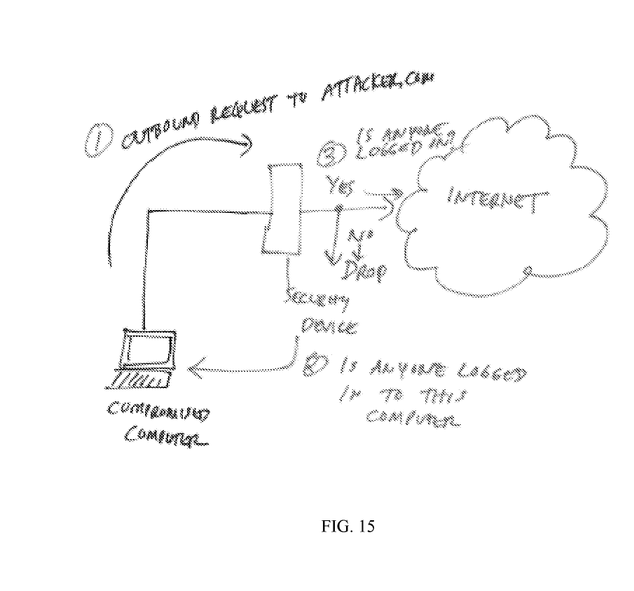

o. FIG. 15 represents an embodiment of the invention according to which it is used to identify covert, clandestine or malicious communications bound for outside of the network.

### DETAILED DESCRIPTION OF THE INVENTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Active session validation/two-way authentication. By checking whether a user is actively/interactively logged into a computer terminal, a secure device can identify, report, notify, prompt, or block pass-the-hash attacks. This can be accomplished several ways, including by examining the source of the request to determine if the host reflects characteristics consistent with an interactive login, or sending a message, or triggering an event that results in the user being prompted to validate the user's full password or other attributes indicating ‘presence’. The following examples are intended to help illustrate aspects of the invention, but are not intended to limit the invention to these or any other specific embodiments.

### Example 1

Examining the system registry for loaded profiles in HKEY_USERS registry or another workstation data artifact. FIG. 6 shows a compromised computer sending an authentication or access request to a target computer. A security device according to the invention is monitoring communications and detects the request. The security device causes a query to be sent to the originating computer to determine from the HKEY_USER registry to determine if the sender of the communication is logged in. If examination of the HKEY_USER registry reflects that the sender is logged on, the security device may be allow the request to pass to the intended recipient. If examination of the HKEY_USER registry reflects that the sender is not logged on, the security device may take any one or more of several actions, including dropping the request from the network, reporting the request to an administrator and/or notifying the purported sender, the target, and/or any other parties. According to an aspect of this embodiment, no other device is queried, and no information from any other device is relied upon to make the determination concerning the validity of the access request. This is referred to as a zero-trust policy.

### Example 2

Examining local system log data to identify interactive logins or failed login/pass-the-hash signatures. FIG. 7 shows a compromised computer sending an authentication or access request to a target computer. A security device according to the invention is monitoring communications and detects the request. The security device causes a query to be sent to the originating computer to determine from the local system log data any interactive logins, failed logins or other anomalous login events. If examination of the log data reflects that the sender is logged on, the security device may be allow the request to pass to the intended recipient. If examination of the log data reflects that the sender is not logged on, or if it reflects other anomalous login data, the security device may take any one or more of several actions, including dropping the request from the network, reporting the request to an administrator and/or notifying the purported sender, the target, and/or any other parties. According to an aspect of this embodiment, a zero-trust policy may be employed.

### Example 3

Querying WINS servers for login information for a particular user. FIG. 8 shows a compromised computer sending an authentication or access request to a target computer. A security device according to the invention is monitoring communications and detects the request. The security device causes a query to be sent to a WINS server for login information relating to the user from request is purported to have been sent. If examination of the information from the WINS server, either alone or in conjunction with information obtained from the originating computer, reflects that the sender is logged on, the security device may be allow the request to pass to the intended recipient. If examination of the information from the WINS server, either alone or in conjunction with information obtained from the originating computer, reflects that the sender is not logged on, or if it reflects other anomalous login data, the security device may take any one or more of several actions, including dropping the request from the network, reporting the request to an administrator and/or notifying the purported sender, the target, and/or any other parties.

### Example 4

Query netbios for logged-in users. FIG. 9 shows a compromised computer sending an authentication or access request to a target computer. A security device according to the invention is monitoring communications and detects the request. The security device causes a query to be sent to the originating computer to determine from the netbios if the purported sender of the request is actually logged in. If examination of the netbios reflects that the sender is logged on, the security device may allow the request to pass to the intended recipient. If examination of the netbios does not reflect that the purported sender is logged on, the security device may take any one or more of several actions, including dropping the request from the network, reporting the request to an administrator and/or notifying the purported sender, the target, and/or any other parties. According to an aspect of this embodiment, a zero-trust policy may be employed.

### Example 5

In an active directory, Kerberos, or LDAP environment, sensors or logic may be deployed in line with, or receive feeds (possibly from span ports) from, directory servers to watch for events characteristic of a legitimate login. Another set of sensors/devices may be deployed to query this standalone repository of identity information or logic. FIG. 10 shows a representation according to this embodiment. As shown in FIG. 10, a security device according to the invention is deployed in line with an active directory or LDAP server, and is configured to build a store of authenticated users based on monitoring of traffic. Another security device may detect an access or authentication request from a computer, and the second security device may send a query to the first security device as to whether the purported sender of the access/authentication request logged on to the originating device. If the first security device reflects that the purported sender logged on to that device within a specified time frame, the second security device may allow the request to pass to the intended recipient. If the first security device reflects that the purported sender has not logged on to the originating device within a specified time frame, the second security device may take any one or more of several actions, including dropping the request from the network, reporting the request to an administrator and/or notifying the purported sender, the target, and/or any other parties. According to an aspect of this embodiment, a zero-trust policy may be employed, in that the first security device does not rely on any information sent to it by any other device. Instead, the first security device passively monitors the network environment and builds a database of information reflective of properly authenticated users and activity over the course of time. According to this embodiment, the system does not rely on any network servers or other network devices for authentication information specific to the event/authentication request at hand.

### Example 6

Querying enterprise log data/active directory/Kerberos logs for valid interactive/console logins. FIG. 11 shows a representation according to this embodiment. As shown in FIG. 11, a security device according to the invention is deployed in line with one or more networked computers and may detect an access or authentication request from a computer. According to this embodiment, the security device queries the domain controller log data for valid logins. If valid and timely login information is found, the security device may allow the request to pass to the intended recipient. If not, the security device may take any one or more of several actions, including dropping the request from the network, reporting the request to an administrator and/or notifying the purported sender, the target, and/or any other parties

### Example 7

Sending a message, or triggering an event that results in the user being prompted to validate the user's full password or other attributes indicating ‘presence’. Such messaging may be sent to the active screen terminal via messenger, using the standard or another similar mechanism to prompt the user to validate the authenticity of the action. The mechanism may also be triggered using a normal part of the communications protocol being monitored, which may include altering dropping, modifying, or blocking portions of session establishment to cause the system to fall-back and prompt for a password. FIG. 12 shows a representation of this embodiment. FIG. 12 shows a compromised computer sending an authentication or access request to a target computer. A security device according to the invention is monitoring communications and detects the request. The security device causes a verification request to pop up on the originating computer's screen asking the user to confirm that he/she is logged in and/or to confirm that he/she has sent the request at issue. This method can be very effective, as computer attackers very often do not have control or visibility of what shows up on the computer monitor. If the user validates his/her identity and/or access request, then the request is allowed to pass to the intended recipient. If not, the security device may take any one or more of several actions, including dropping the request from the network, reporting the request to an administrator and/or notifying the purported sender, the target, and/or any other parties. According to an aspect of this embodiment, a zero-trust policy may be employed

### Example 8

One or more devices may exist on a network to prevent identity-based attacks, and this system is capable of pushing or pulling configuration data via a central console. An administrator is able to configure monitor/report/block actions based on this configuration, allowing for a single point of configuration for all sensors on a network. This system can then be configured to monitor for signs of compromise or abuse involving identities and authentication credentials. FIG. 13 is a representation of this embodiment.

Once configured, the sensors may track and report activity to a central console and database, optionally sending the data to an integrated log management solution to facilitate greater visibility into identity information and data. FIG. 14 is a representation of this embodiment.

### Example 9

In terms of tracking malicious activity on the network, the system may also be configured to integrate with perimeter network devices to identity covert, clandestine, or malicious inbound or outbound connections. Integrating identity information into edge, perimeter, or concentrator systems allows network owners to identify activity that is automated in nature and that has not originated from a logged-in user. This is similar to the pass-the-hash detection identified previously: the system may check the state and status of user identity on a workstation to determine whether the activity is originating from an application or component, not from a user. FIG. 15 is a representation of this embodiment. According to this embodiment, a compromised computer sends an outbound request to a device operated by the hacker/attacker. A security device according to the invention, monitoring outbound communications from the computer and/or the network sends a query to the originating computer to determine whether the purported sender is actually logged onto the originating computer. If examination of the log data reflects that the sender is logged on, the security device may be allow the request to pass to the intended recipient. If examination of the log data reflects that the sender is not logged on, or if it reflects other anomalous login data, the security device may take any one or more of several actions, including dropping the request from the network, reporting the request to an administrator and/or notifying the purported sender, the target, and/or any other parties. According to an aspect of this embodiment, a zero-trust policy may be employed.

1. A computer-implemented method for detecting anomalous or improper use of identity information in communications between electronic devices comprising:
detecting an authentication request transmitted from a first electronic device to a second electronic device;
collecting information sufficient to indicate whether the first electronic device reflects characteristics consistent with an interactive login;
making a determination of whether to allow the authentication request to pass to the second electronic device based on the information collected.

2. A method according to claim 1, wherein the electronic devices are on a network.

3. A method according to claim 1, wherein the electronic devices are on a wireless network.

4. A method according to claim 1, wherein the electronic devices are computers

5. A method according to claim 1, wherein at least one of the electronic devices is a mobile device

6. A method according to claim 1, wherein the collecting information step does not include collecting identity information from any device other than the first electronic device

7. A method according to claim 1, wherein the collecting information step does not include collecting authentication information from any device other than the first electronic device

8. A method according to claim 1, wherein the collecting information step comprises examining the system registry of the first electronic device for any loaded profile or other workstation data artifact to determine if an authorized user is logged onto the first electronic device.

9. A method according to claim 1, wherein the collecting information step comprises examining local system log data of the first electronic device to determine whether there have been interactive logins, failed logins, pass-the-hash signatures or other login events

10. A method according to claim 1, wherein the collecting information step comprises querying WINS servers for login information for a particular user.

11. A method according to claim 1, wherein the collecting information step comprises querying the netbios of the first electronic device for logged-in users.

12. A method according to claim 1, wherein the determination is made based on a zero-trust policy according to which no data concerning the login status of the first electronic device is relied upon except for data retrieved from, and not initiated by, the first electronic device.

13. A method according to claim 1, wherein the collecting information step comprises trigging an event that results in a user-prompt at the first electronic device for validation of a full password or other attribute indicating a user's presence.

14. Computer readable medium containing computer readable instructions for detecting anomalous or improper use of identity information in communications between electronic device, said instructions comprising instructions for:
detecting an authentication request transmitted from a first electronic device to a second electronic device;
collecting information sufficient to indicate whether the first electronic device reflects characteristics consistent with an interactive login;
making a determination of whether to allow the authentication request to pass to the second electronic device based on the information collected.

15. A computer system configured to detect anomalous or improper use of identity information in communications between electronic devices comprising a device configured to:
detect an authentication request transmitted from a first electronic device to a second electronic device;
collect information sufficient to indicate whether the first electronic device reflects characteristics consistent with an interactive login;
determine of whether to allow the authentication request to pass to the second electronic device based on the information collected.
